(19) United States
(12) Patent Application Publication
(10) Pub. No.: US 2006/0161203 A1
(43) Pub. Date: Jul. 20, 2006

(54) PASSIVE MOTION BODY ARTICULATING APPARATUS AND METHOD

(75) Inventors: Christopher D. Endara, Village of Palmetto Bay, FL (US); Matthew J. Endara, Palmetto Bay, FL (US); Wyatt Getst, Davie, FL (US); Jorge M. Sotelo, Miami, FL (US); Kenneth C. West, Miami Beach, FL (US)

Correspondence Address: John Christopher;Christopher & Weisberg, P.A., Suite 2040, 200 East Las Olas Boulevard, Fort Lauderdale, FL, 33301, US

(73) Assignee: Total Motion Development, Inc.

(21) Appl. No.: 11/037,851

(22) Filed: Jan. 18, 2005

(51) Int. Cl. A61H 1/02

(52) U.S. Cl. 606/241; 601/24

(57) ABSTRACT

A physical therapy chair having a first support element defining a seating surface, a second support element defining a backrest, wherein the second support element is pivotable with respect to the first support element and rotatable with respect to the first support element. The chair further including an arm support element coupled to the second support element, as well as a first motion actuator coupled to the second support element to rotate the second support element with respect to the first support element, and a second motion actuator coupled to the second support to pivot the second support element with respect to the first support element. The chair also includes a first controller that allows a user to modify an operational characteristic of the first motion actuator and a second controller that allows a user to modify an operational characteristic of the second motion actuator.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to therapeutic passive motion devices.

### BACKGROUND OF THE INVENTION

A large number of individuals experience some sort of back pain, which may range from a mild soreness to a chronic ailment that can impair a wide range of physical activities. Moreover, individuals who have undergone a surgical procedure involving the torso region may experience fatigue and pain in their spine, back, and supporting muscles. One therapeutic approach for both back pain as well as postoperative recovery involves exercise through a certain range of movement, and numerous exercise devices have been developed to aid in such therapeutic motion. However, an individual suffering from back pain or postoperative fatigue may find such devices unsuitable because of the seriousness of the pain, and further, because there may be a risk of additional injury to the back, spine, and supporting muscles when engaging an exercise machine.

An approach to limit the potential of further injury while allowing for therapeutic motion includes the use of a passive motion machine, which exercises the muscles of an individual without requiring the individual to put forth an active effort. Such machines are generally powered by some sort of motor, and generally provide movement of the torso. However, conventional passive motion machines are generally limited in their available axes of movement, i.e., there may be a single axis of bending or rotation. Alternatively, there may be multiple axes of movement available, but the motion is likely powered by a single motor or drive element, and as such, the range of motion and patterns of motion available for therapy remain limited. With a single drive element powering a passive motion machine, the overall patterns of motion, whether being about one axis or multiple axes, are linked, and the only way to vary the pattern of movement is to physically change the coupling system between the drive element and the support portions of the machine. Such an alteration takes time and prevents a user from instantaneously modifying the motion experienced while using the machine.

In light of the above limitations, it would be desirable to provide a passive motion apparatus capable of moving an individual about multiple axes of motion, with each axis of motion being independently controlled and powered, as to allow various sequences of movement through the widest range of motion.

### SUMMARY OF THE INVENTION

The present invention advantageously provides a passive motion apparatus, more specifically, a physical therapy chair, capable of moving an individual about multiple axes of motion, with each axis of motion being independently controlled and powered, as to allow various sequences of movement through the widest range of motion.

The physical therapy chair of the present invention includes a first support element defining a seating surface and a second support element defining a backrest. The second support element is both pivotable and rotatable with respect to the first support element, and can include an arm support element coupled to the second support element. A first motion actuator is coupled to the second support element to rotate the second support element about the first support element, and a second motion actuator is coupled to the second support to pivot the second support element about the first support element. The first motion actuator operates independently of the second motion actuator, allowing the pivoting and rotating motion to be manipulated independently, thereby increasing the patterns of motion available through the use of the physical therapy chair.

Further, a first controller allows for the modification of an operational characteristic of the first motion actuator, and a second controller allows for the modification of an operational characteristic of the second motion actuator. The operational characteristics can include range of motion, rate of motion, direction of motion, and further provide for turning the power on or off. The controllers may be integrated into the arm support element to ease the control and use of the chair.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a perspective view of a physical therapy chair in accordance with the present invention;

FIG. 2 depicts an alternative perspective view of a physical therapy chair in accordance with the present invention;

FIG. 3 shows a diagram of a user interface in accordance with the present invention.

FIG. 4 illustrates a top view of a physical therapy chair in accordance with the present invention;

FIG. 5 illustrates an additional top view of a physical therapy chair in accordance with the present invention; and

FIG. 6 shows a side view of a physical therapy chair in accordance with the present invention.

### DETAILED DESCRIPTION OF THE INVENTION

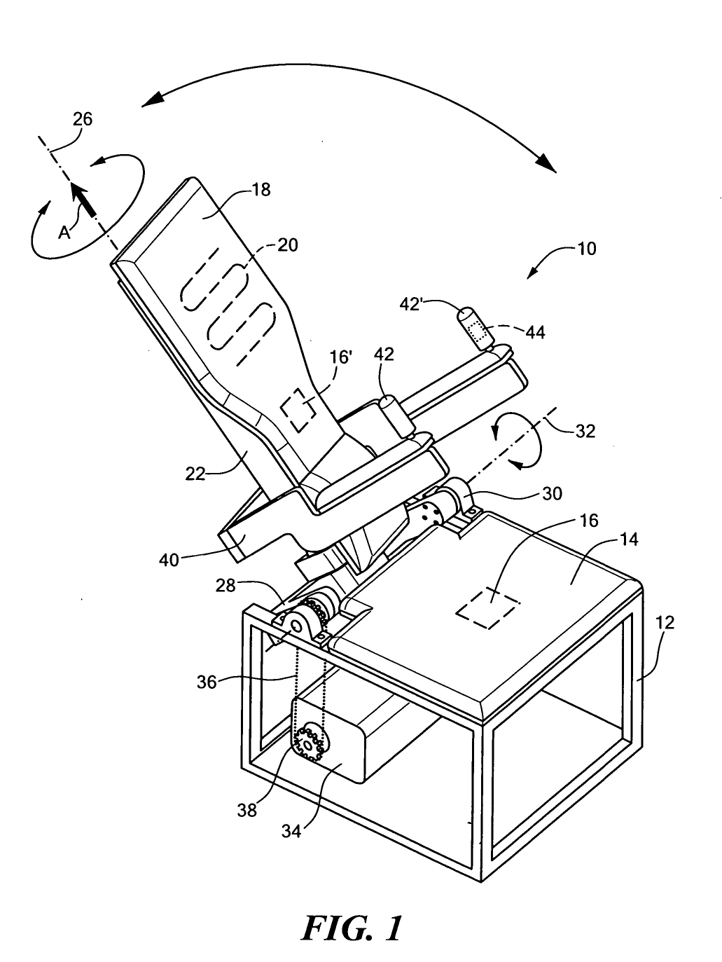

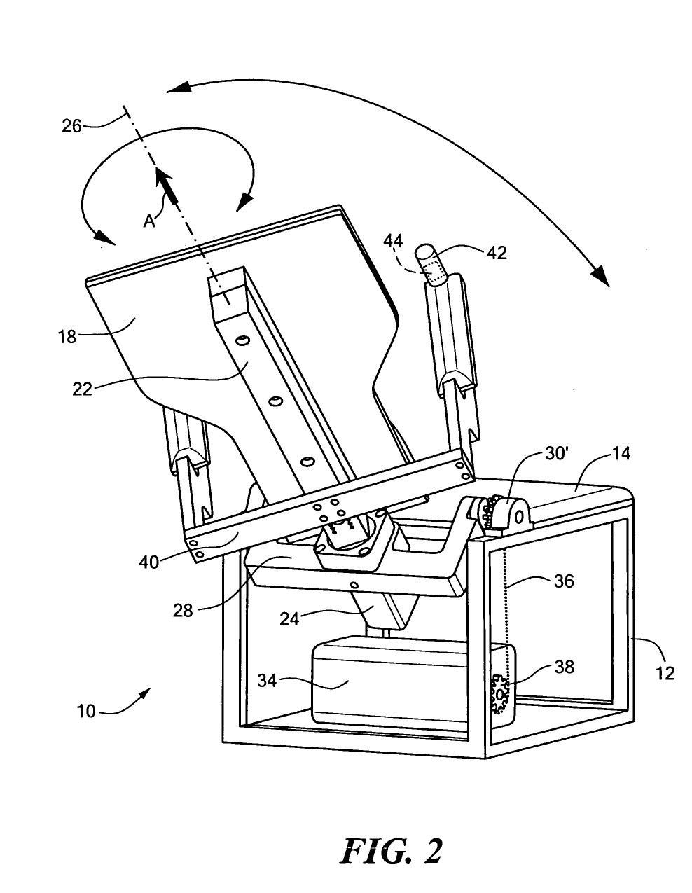

In an exemplary embodiment, the present invention provides a passive motion apparatus, specifically, a physical therapy chair 10, as shown in FIGS. 1 and 2. The physical therapy chair 10 includes a support frame 12, which provides the underlying structural support to the other components of the passive motion apparatus 10. A first support element 14 is coupled to the support frame 12 and defines a seating surface which is adapted to support a lower body portion of a user. The first support element 14 remains stationary and affixed to an upper surface of the support frame 12, and may include cushioning or other means for providing surface contours which conform to the lower extremities of a user. Additionally, the first support element 14 may include additional therapeutic provisions, such as a vibrating or stimulating element 16.

The physical therapy chair 10 further includes a second support element 18 that defines a backrest adapted to support an upper body, or torso region, of a user. The second support element 18 can include cushioning or other means to ergonomically conform to the shape of a user. Furthermore, additional therapeutic elements, such as a heating element 20 or vibrating or stimulating element 16′, may be integrated with the second support element 18. The second support element 18 is generally located adjacent to the first support element 14, and is affixed to a rotation column 22, which extends down the back of the second support element 18. Although the rotation column 22 is illustrated as a single rectangular structure, it may include lateral extensions (not shown) or other variations to increase the support for the second support element 18. The rotation column 22 is directly coupled to a first motion actuator 24, which may be an electric motor or other powered means of providing movement. The coupling of the rotation column 22, and thus the second support element 18, to the first motion actuator 24 provides for pivoting about a first axis 26 that is parallel to the second support element 18. The first motion actuator 24 drives the movement of the second support element 18 about the first axis 26. In addition to the pivoting movement of the second support element 18 about first axis 26, the second support element may be selectively separable from the first support element 14 parallel to the first axis 26. For example, the second support element 18 may be slideably affixed to the rotation column 22. The slideable affixation allows the second support element 18 to move along the rotation column 22, as indicated by arrow A, to provide a stretching or distraction type of motion. The affixation of the second support element 18 may be substantially friction-free such that gravity provides the stretching movement when the second support element is fully extended, or the motion may be actively powered by an electric motor or the like (not shown).

The first motion actuator 24 is affixed to a u-shaped swing arm 28 that extends substantially horizontally across a width of the frame 12 perpendicular to the first axis 26. The swing arm 28 is coupled to two swing arm mounts 30, 30′ located at opposite sides of the frame 12, such that the swing arm is moveable about a second axis 32 located between the first and second support elements. The coupling of the swing arm 28 at the swing arm mounts 30, 30′ may include ball bearings or other connection means that provide support for the swing arm 28 yet allow the swing arm to pivot or rotate at the coupling point. The pivotable affixation of the swing arm 28 allows the second support element 18, the rotation column 22 and the first motion actuator 24 to move in unison about the second axis 32. A second motion actuator 34, such as an electric motor, is coupled to the swing arm 28, for example, by a chain 36 and a sprocket 38, and drives the movement of the second support element 18 about the second axis 32. Further, the second motion actuator 34 may be affixed to the frame 12. While the frame 12 is shown as an open structure, panels may be provided to conceal the inner workings of the physical therapy chair 10.

The physical therapy chair 10 also includes an arm support element 40. The arm support element 40 is coupled to the second support element 18 as to define a first surface for supporting a first arm of a user, as well as a second surface for supporting a second arm of a user. The arm support element 40 may include padding or cushioning to provide additional comfort. The arm support element 40 can be affixed to the rotation column 22 or the second support element 18, allowing uniform movement of both the second support element 18 and the arm support element 40 throughout the motion pattern of the second support element 18. Moreover, the arm support element 40 may further include handles 42, 42′.

A user interface 44 can be integrated with the arm support element 40 through the handles 42, 42′ such that an input experienced by the handles results in the manipulation of the motion actuators. In an exemplary embodiment, the handles are operated analogous to a joystick to control the motion of the physical therapy chair 10, and may further include a push-button, scrolling wheel, or other input means to modify the operational characteristics of the motion actuators.

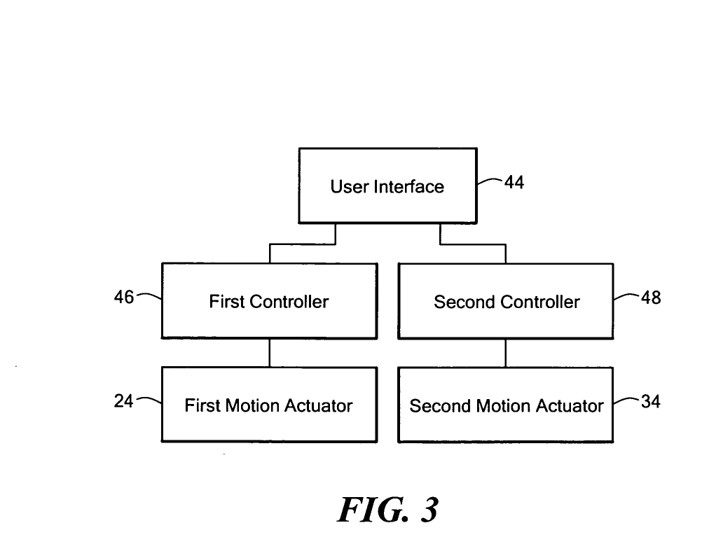

Now referring to FIG. 3, the user interface 44 operates generally by sending signals, either wirelessly or through conventional wiring, to a first controller 46 and a second controller 48. The first controller 46 allows for control and modification of the operation of the first motion actuator 24. The first controller 46 can be used to modify the speed and direction of motion about the first axis 26 by manipulating the speed and direction of the first motion actuator 24. For example, the first controller 46 can increase the rate of rotation of the first motion actuator 24, which will directly increase the rate of motion of the second support element 18, and thus the twisting motion experienced. Additionally, the first controller 46 allows for manipulation of the direction of rotation about the first axis 26, i.e., whether in a clockwise or counterclockwise direction. These operational characteristics of speed and direction may be modified during use of the physical therapy chair 10, and may further be changed concurrently, that is to say, the speed and direction may be modified simultaneously. The second controller 48 operates similarly to the first controller 46, except that the second controller controls and manipulates the operation of the second motion actuator 34. Through the use of the second controller 48, motion of the second support element 18 about the second axis 32 can be modified, including both rate and direction of movement.

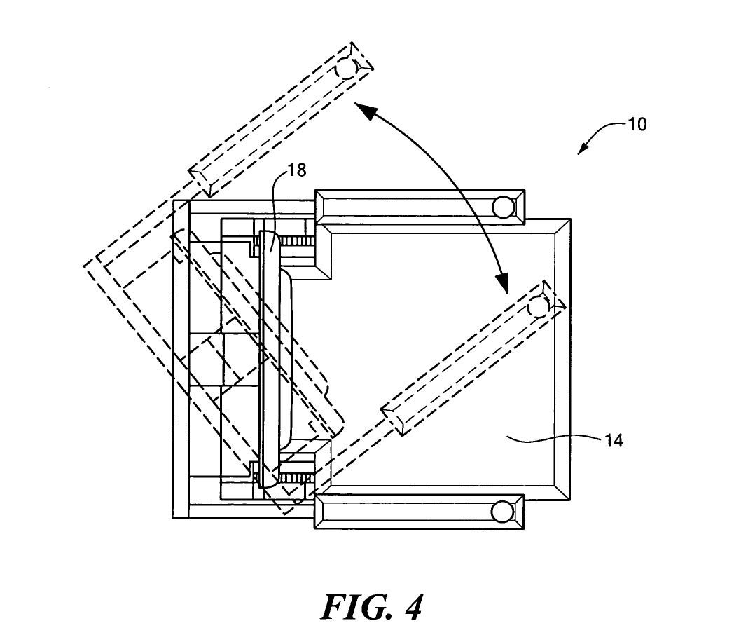

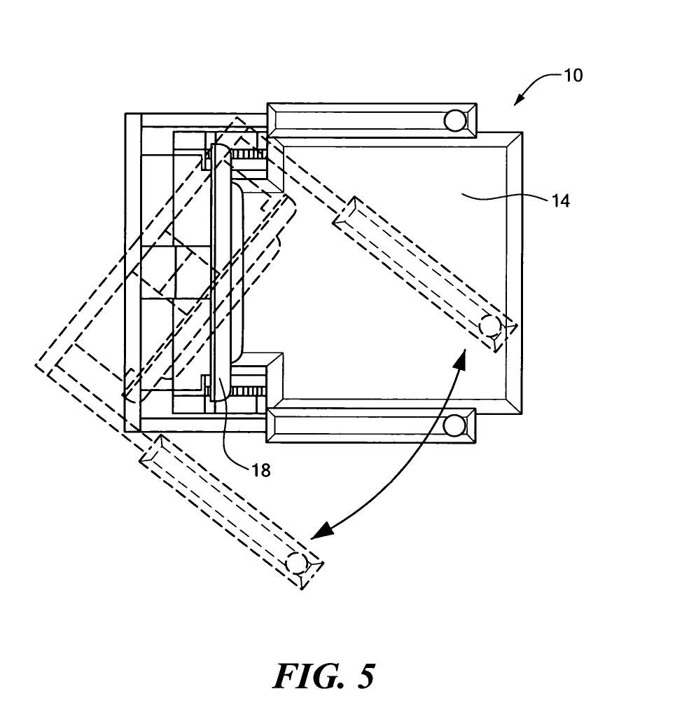

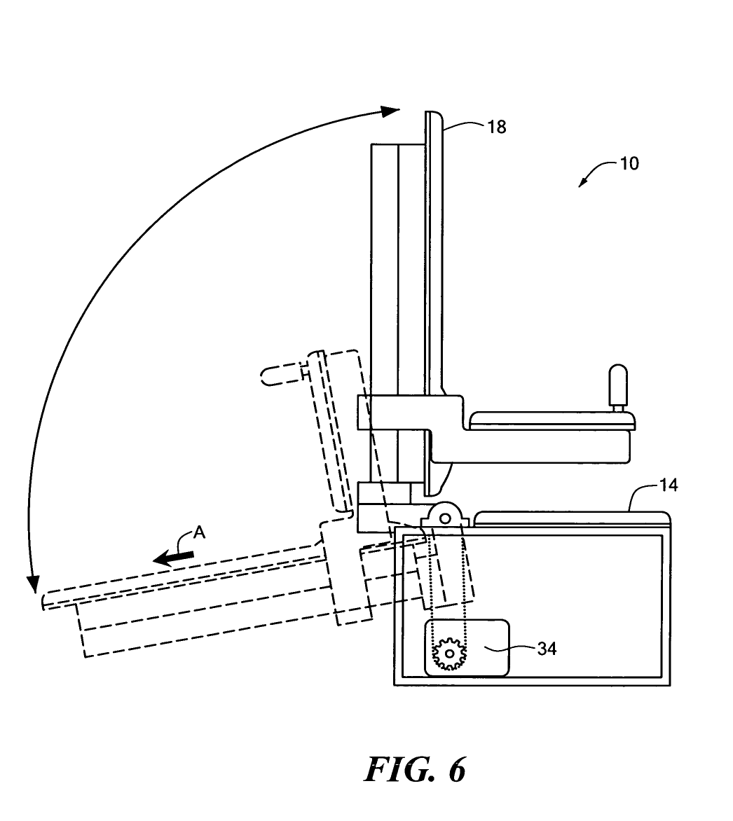

Now referring to FIGS. 4 and 5, the independent coupling and operation of the first motion actuator 24 and the second motion actuator 34 to their respective axes of motion allows movement about either axis which may be modified independently of the other, resulting in the capability of the physical therapy chair 10 having a wide range of potential patterns of movement when in use. When in use, the physical therapy chair 10 provides movement about the first axis 26 that results in a twisting motion of a user, i.e., rotation of the upper torso with respect to the lower portion of a user. Furthermore, as shown in FIG. 6, movement of the physical therapy chair 10 about the second axis 32 provides flexion and extension at or about the waist, i.e., the user bends forward and then straightens, analogous to a movement of sitting up, then laying down. In addition, the stretching or distraction movement indicated by arrow A provides further motion of a user. The figures depicting the motion of the chair are merely illustrative of the capacity of the movement of the second support element and should not be construed as limiting the range of motion, as the rotation about the first axis 26 may extend up to 90 degrees, and flexion and extension about the second axis 32 may provide motion exceeding 180 degrees from an upright position.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A physical therapy chair, comprising:
a first support element;
a second support element pivotable with respect to the first support element and rotatable with respect to the first support element;
a first motion actuator coupled to the second support element to rotate the second support element with respect to the first support element; and
a second motion actuator coupled to the second support to pivot the second support element with respect to the first support element.

2. The physical therapy chair of claim 1, wherein the second support element is selectively separable from the first support element.

3. The physical therapy chair of claim 1, wherein the first support element defines a seating surface.

4. The physical therapy chair of claim 1, wherein the second support element defines a backrest.

5. The physical therapy chair of claim 1, wherein the first motion actuator operates independently of the second motion actuator.

6. The physical therapy chair of claim 1, further comprising an arm support element coupled to the second support element.

7. The physical therapy chair of claim 1, further comprising a first controller that allows a user to modify at least one operational characteristic of the first motion actuator; and a second controller that allows a user to modify at least one operational characteristic of the second motion actuator.

8. The physical therapy chair of claim 7, wherein the first controller and second controller are integrated with the arm support element.

9. The physical therapy chair of claim 7, wherein the first controller and second controller are integrated into a single interface.

10. The physical therapy chair of claim 7, wherein an operational characteristic includes rate of movement.

11. The physical therapy chair of claim 7, wherein an operational characteristic includes turning the power on.

12. The physical therapy chair of claim 7, wherein an operational characteristic includes direction of movement.

13. The physical therapy chair of claim 7, wherein an operational characteristic includes range of movement.

14. The physical therapy chair of claim 1, wherein the first motion actuator is an electric motor.

15. The physical therapy chair of claim 1, wherein the second motion actuator is an electric motor.

16. The physical therapy chair of claim 1, further comprising a vibrating element integrated with the second support element.

17. The physical therapy chair of claim 1, further comprising a heating element integrated with the second support element.

18. A physical therapy chair, comprising:
a first support element defining a seating surface;
a second support element defining a backrest, wherein the second support element is pivotable with respect to the first support element and rotatable with respect to the first support element;
an arm support element coupled to the second support element, wherein the arm support element includes a handle;
a first motion actuator coupled to the second support element to rotate the second support element with respect to the first support element; and
a second motion actuator coupled to the second support to pivot the second support element with respect to the first support element,
wherein the first motion actuator operates independently of the second motion actuator;
a first controller that allows a user to modify an operational characteristic of the first motion actuator; and
a second controller that allows a user to modify an operational characteristic of the second motion actuator,
wherein the first and second controllers are integrated with the arm support element.

19. The physical therapy chair of claim 20, wherein the second support element includes a heating element.

20. The physical therapy chair of claim 20, wherein the second support element includes a vibrating element.
